(19) United States
(12) Patent Application Publication
(10) Pub. No.: US 2005/0036336 A1
(43) Pub. Date: Feb. 17, 2005

(54) Swiveling light pen with a silicone grip

(76) Inventor: Li Yun Yang, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/639,451

(22) Filed: Aug. 13, 2003

(51) Int. Cl. G06G 1/02

(52) U.S. Cl. 362/579

(57) ABSTRACT

A lighted pen has a hollow pen body, a transparent gripping portion, and a control device assembled at a top end of the pen body. The pen body has a conductive swiveling mechanism, and a light seat. The swiveling mechanism has a pushing rod. The light seat has a pen tip assembled in a front portion thereof, a light embedded therein, and a battery chamber. One end of the light is rearwardly in contact with the batteries, and the other end is exposed outside the light seat. The pushing rod contacts another end of the batteries. The gripping portion has a connecting ring assembled on a distal end thereof for connecting the pen body and a spring disposed in the connecting ring to contact the exposed terminal of the light. The control device rotates the swiveling mechanism and has a push-button switch mounted therein for controlling light.

### BACKGROUND OF THE INVENTION

1. Field of the Invention

The present invention relates to a swiveling light pen with a silicone grip, and particularly to a pen capable of rotating out a pen tip for writing combined with an independent light control and silicone grip portion for comfortable holding, so that the pen can be used in dark place.

2. Description of the Prior Art

Lighted pens are popular for temporarily writing in conditions of insufficient light. However, conventional lighted pens are usually powered by a battery and have the following disadvantages:

1. Conventional lighted pens usually have a separate pen cap, which is easily lost. Additionally, a push-button is used to retract the pen tip, but this makes an undesirable clicking. The clicking can be avoided by employing a rotational method of retracting or extruding the pen tip, but this method is seldom used in the conventional art.

2. The position of the battery in the conventional lighted pen results in discomfort in use. The battery is usually located in the butt end of the pen, such that the pen leans back during writing and requires additional force from the writer.

3. The area illuminated by the pen is limited because the conventional lighted pen is usually between 14 cm and 14.8 cm for convenient carrying and the light is disposed near the tip of the pen.

### SUMMARY OF THE INVENTION

Accordingly, an object of the present invention is to provide a swiveling light pen with a silicone grip, and more particularly, to provide a pen with a module combining a light switch and a pen-lead rotating button for convenient assembling. The center of gravity is designed to be located substantially in the middle of the tip end of the pen.

In order to achieve the above objects, the present invention according to one aspect thereof provides a swiveling light pen with a silicone grip comprising a hollow pen body having a conductive swiveling mechanism mounted therein, and a transparent light seat disposed before the swiveling mechanism. The swiveling mechanism comprises an insulative annular body slidably assembled therein, and a metal pushing rod affixed in a center of the annular body. The light seat comprises an ink cartridge slot formed in a front portion thereof for receiving a pen tip, a light embedded therein, and a battery chamber formed in a rear portion thereof for receiving batteries. The light has two terminals, one terminal extending rearward into the battery chamber for electrically connecting to a pole of the batteries, and the other terminal outwardly extending and exposed outside the light seat. The pushing rod contacts another pole of the batteries. A hollow transparent gripping portion receives the light seat and the pen tip, having a metal connecting ring assembled on a distal end thereof for connecting a front portion of the pen body, a spring disposed therein for pushing the light seat and contacting the exposed terminal of the light. A control device includes a rotating button, a metal tube affixed in the rotating tube and engaged with the swiveling mechanism, an insulative containing ring affixed in the metal tube for receiving a contact, a metal spring against the contact and the pushing rod of the pen body, and a push-button switch mounted in the rotating button for controlling electrical contact between the contact with the metal tube. When the rotating button of the controlling device is rotated, the swiveling mechanism rotates simultaneously so that the insulative annular body slides forward and the insulative annular body drives the pushing rod forward.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a cross-sectional view of a swiveling light pen with a silicone grip of the present invention;

FIG. 1A is a cross-sectional view of a light seat of the swiveling rotator light pen of the present invention;

FIG. 1B is a cross-sectional view of a swiveling mechanism of the swiveling rotator light pen of the present invention;

FIG. 1C is a cross-sectional view of a controlling device of the swiveling rotator light pen of the present invention; and

FIG. 2 is an exploded view of the swiveling rotator light pen of the present invention; and

FIG. 3 is a perspective view of the swiveling rotator light pen of the present invention.

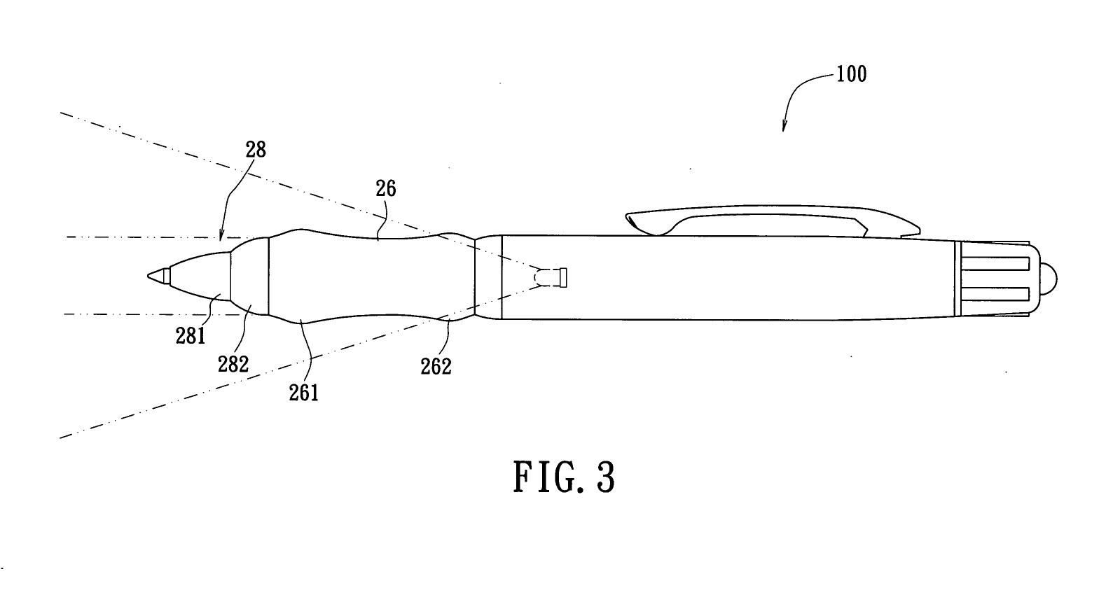

### DESCRIPTION OF THE PREFERRED EMBODIMENT

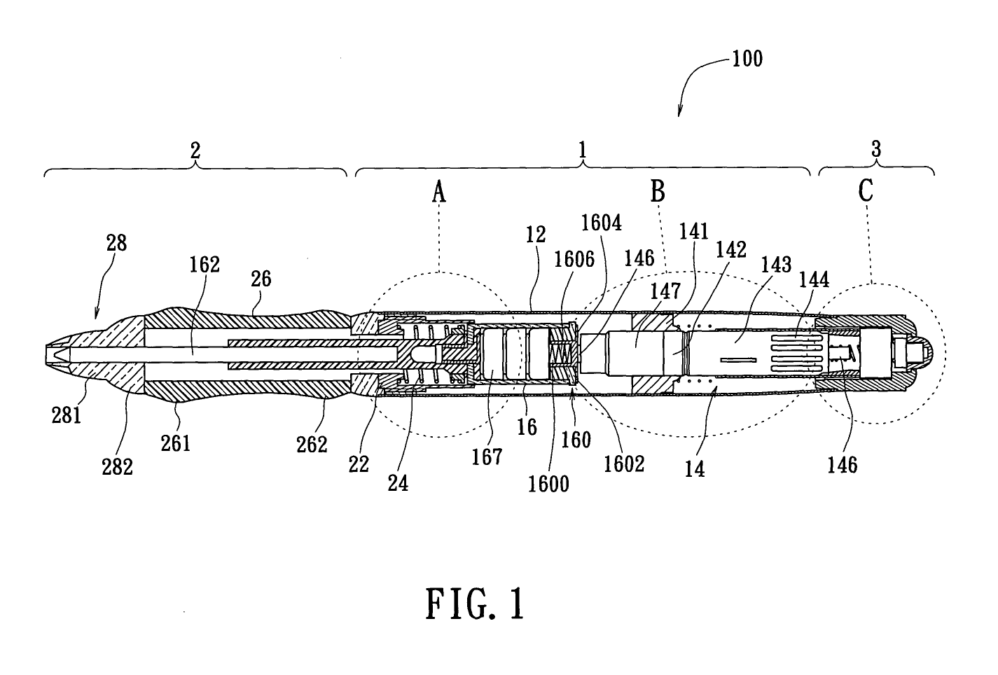

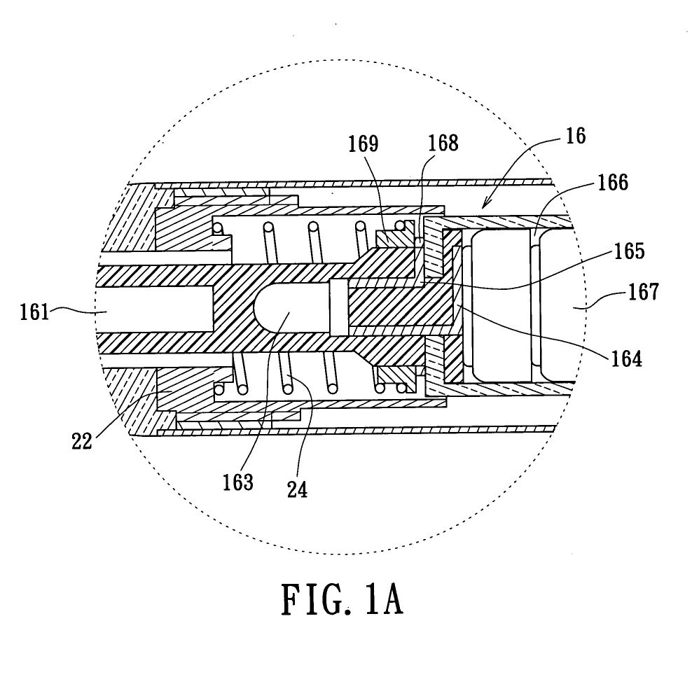

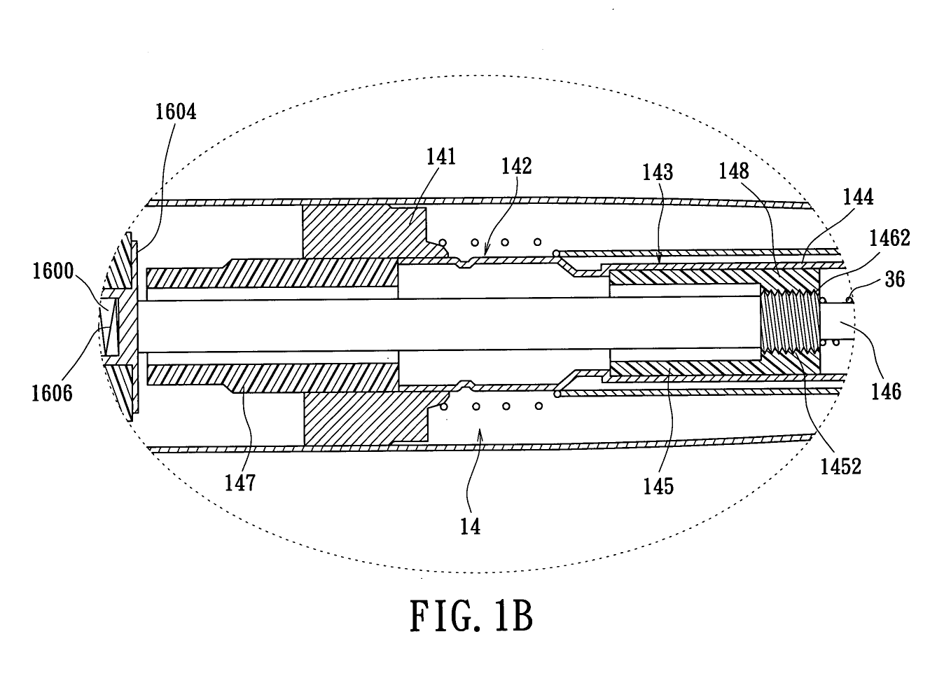

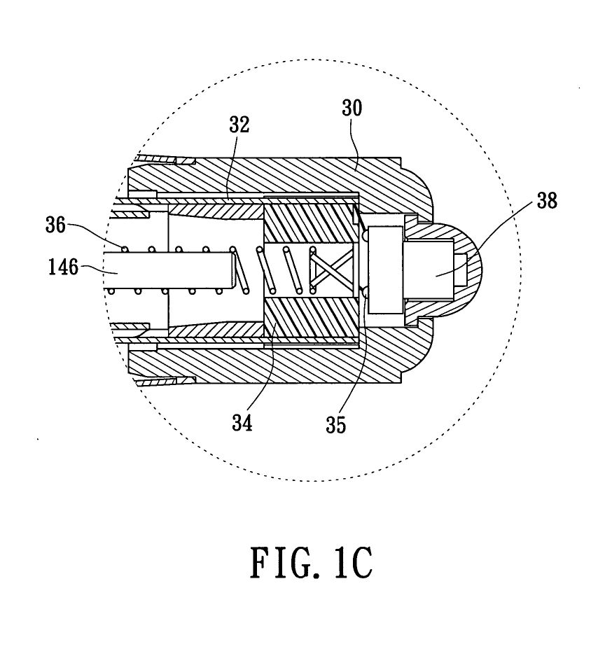

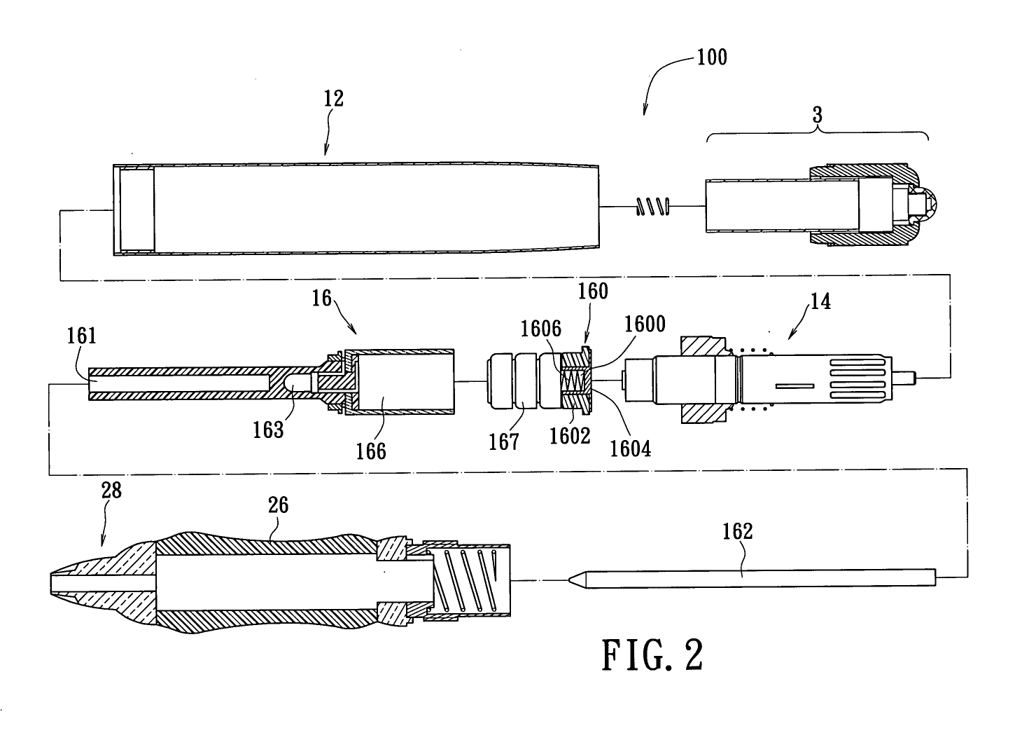

Referring to FIGS. 1 and 2, a swiveling light pen with a silicone grip 100 comprises a hollow pen body 1, a hollow transparent gripping portion 2 connected to a front end of the pen body 1, and a control device 3 connected to a rear end of the pen body 1.

The hollow pen body 1 has a metal shell 12, a conductive swiveling mechanism 14 mounted in a middle thereof, and a transparent light seat 2 disposed before the swiveling mechanism 14.

The swiveling mechanism 14 has a metal retaining portion 141 assembled on a front end thereof and retained in the pen body 1, a rotating portion assembled on a rear end of the retaining portion 141, and an engaging sleeve 143 connected with a distal end of the rotating portion 412. The engaging sleeve 143 is formed with longitudinal flanges 144 on an outer circumference thereof, an insulative annular body 145 slidably mounted in the engaging sleeve 143, and a metal pushing rod 146 affixed in a center of the annular body 145. The retaining portion 141 is formed with an insulative sleeve 147 for the pushing rod 146 to pass through and isolated from the retaining portion 141.

The insulative annular body 145 is formed with a plurality of protrusions 148 on a periphery thereof mating with the longitudinal flanges 144 of the engaging sleeve 143 for slidably engaged in the engaging sleeve 143. The insulative annular body 145 has screws 1452 formed on an inner periphery thereof, and the metal pushing rod 146 is formed with a screwing portion 1462 corresponding to the screws 1452 of the insulative annular body 145 for screwing to each other.

The light seat 16 comprises a ink cartridge slot 161 formed in a front portion thereof for receiving a pen tip 162, a light 163 embedded therein and a battery chamber 166 formed on a rear portion thereof for receiving batteries 167. The light 163 has two terminals 164, 165. One of the terminals is extends rearward into the battery chamber 166 to connect electrically to a pole of the batteries 167 and other terminal extends outwardly and is exposed outside the light seat 16. The pushing rod 146 contacts another pole of the batteries 167. The light 163 of the light seat 16 can be a LED (Light Emitting Diode) or a light bulb and is disposed before a connecting ring 22 of the gripping portion 2. The connecting ring 22 is disposed at an end of the gripping portion 2. The light seat 16 has a cover 160 assembled at a distal end of the battery chamber 166 for covering the battery chamber 166. The cover 160 is against the pushing rod 146. The cover 160 has an insulative lid 1602 formed with a central through hole 1600, a conducting plate 1604 covering a side of the insulative lid 1602, and a spring 1606 disposed in the through hole 1600 for elastically and electrically connecting with the conductive plate 1604 and the battery 167.

The hollow transparent gripping portion 2 is shaped in a hollow cylinder for receiving the light seat 16 and the pen tip 162. The gripping portion 2 has the metal connecting ring 22 assembled on a distal end thereof for connecting a front portion of the pen body 1. The connecting ring 22 has a spring 24 disposed therein for pushing the light seat 16 and contacting exposed terminal 165 of the light 163. For stability of electrical connection with the light 163, the light seat 16 further comprises a metal coil 168 mounted on the light seat 16 for connecting the exposed terminal 165 of the light 163, and a metal ring 169 disposed around the light seat 16 and contacting the coil 168. Another end of the metal ring 169 contacts the spring 24 of the connecting ring 22.

The gripping portion 2 is assembled with a transparent silicon portion 26 thereon, and a hollow converging portion 28 formed on a front end of the gripping portion 2. The silicon portion 26 has a concavity in a periphery thereof, and two convexes 261, 262 are respectively formed at two ends thereof for converging light forward. The converging portion 28 is composed of two sections of contiguous conical light-guiding portions 281, 282 with different respective obloquies. Therefore, the two convexes 261, 262 of the silicon portion 26 and the light-guiding portions 281, 282 converge light to enlarge the area lighted and enhance comfort during use.

The control device 3 has a rotating button 30, a metal tube 32 the rotating button 30 and engaged with the engaging sleeve 143 of the swiveling mechanism 14, an insulative containing ring 34 affixed in the metal tube 32 for receiving a contact 35, a metal spring 36 against the contact 35 and the pushing rod 146 of the pen body 1, and a push-button switch 38 mounted in the rotating button 30 for controlling electrical contacting between the contact 35 with the metal tube 32. The metal tube 32 is engaged with the engaging sleeve 143 of the pen body 1.

The push-button switch 38 of the controlling device 3 can independently control the light 163, so that the pen can be used as an illuminating tool. When rotating the rotating button 30 of the controlling device 3, the swiveling mechanism 14 rotates simultaneously so that the insulative annular body 145 slides forward, and the insulative annular body 145 drives the pushing rod 146 forward. Therefore, the pen tip 162 can project for writing, and at that time the user can press the push-button switch 38 and decide to illuminate or not illuminate.

It is of note that the light seat 16 with battery 167 of the present invention is disposed in a front portion of the pen body 1 and the swiveling mechanism 14 is disposed in a middle of the pen body 1, so that the gravity of the pen light 100 is located in the middle of the front part of the pen. The user can thus write easily and comfortably without the pen slanting to the rear.

The sum up of the characteristics and advantages of the present invention:

1. The swiveling light pen with a silicone grip of the present invention has a transparent gripping portion to enlarge the area illuminated and provide greater comfort during use.

2. A module that is combined the light switch and the pen-lead rotating button in a limited space makes assembling convenient and reduces costs.

3. The center of gravity is designed to be located in substantially the middle of the front part of the pen and without electrical elements to reduce costs.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A swiveling light pen with a silicone grip, comprising:
a hollow pen body having a conductive swiveling mechanism mounted therein, and a transparent light seat disposed before the swiveling mechanism; wherein the swiveling mechanism comprises:
an insulative annular body slidably assembled therein; and
a metal pushing rod affixed in a center of the annular body; and
wherein the light seat comprises an ink cartridge slot formed in a front portion thereof for receiving a pen tip;
a light embedded therein; and
a battery chamber formed in a rear portion thereof for receiving batteries; wherein the light has two terminals, one terminal extending rearward into the battery chamber for electrically connecting to a pole of the batteries, and another terminal outwardly extending and exposed outside the light seat, and wherein the pushing rod contacts another pole of the batteries;
a hollow transparent gripping portion for receiving the light seat and the pen tip, having a metal connecting ring assembled on a distal end thereof for connecting a front portion of the pen body, a spring disposed therein for pushing the light seat and contacting the exposed terminal of the light; and
a control device having a rotating button, a metal tube affixed in the rotating button and engaged with the swiveling mechanism, an insulative containing ring affixed in the metal tube for receiving a contact, a metal spring being against the contact and the pushing rod of the pen body, and a push-button switch mounted in the rotating button for controlling electrical contact between the contact with the metal tube;
whereby when the rotating button of the controlling device is rotated, the swiveling mechanism rotates simultaneously so that the insulative annular body slides forward, and the insulative annular body drives the pushing rod forward.

2. The swiveling light pen with a silicone grip as in claim 1, wherein the light of the light seat is an LED (Light Emitting Diode) or a light bulb and is disposed before the connecting ring of the gripping portion.

3. The swiveling light pen with a silicone grip as in claim 1, further comprising a metal coil mounted on the light seat for connecting the exposed terminal of the light, and a metal ring disposed around the light seat and contacting the coil, wherein another end of the metal ring contacts the spring of the connecting ring.

4. The swiveling light pen with a silicone grip as in claim 1, wherein the battery chamber of the light seat has a conductive cover assembled on an end thereof for covering the battery chamber, and the cover is against the pushing rod.

5. The swiveling light pen with a silicone grip as in claim 4, wherein the cover of the light seat has an insulative lid formed with a central through hole, a conducting plate covered on a side of the insulative lid, and a spring disposed in the through hole for elastically and electrically connecting with the conductive plate and the battery.

6. The swiveling light pen with a silicone grip as in claim 1, wherein the swiveling mechanism has a metal retaining portion assembled on a front end thereof and retained in the pen body, a rotating portion assembled on a rear end of the retaining portion, and an engaging sleeve formed with longitudinal flanges on an outer circumference thereof and connected with a distal end of the rotating portion, wherein the insulative annular body is slidably mounted in the engaging sleeve, and the tube of the controlling device is engaged with the engaging sleeve.

7. The swiveling light pen with a silicone grip as in claim 6, wherein the retaining portion is formed with an insulative sleeve for the pushing rod to pass through and isolated from the retaining portion.

8. The swiveling light pen with a silicone grip as in claim 6, wherein the insulative annular body is formed with a plurality of protrusions on a periphery thereof mating with the longitudinal flanges, and screws formed on an inner periphery thereof, and wherein the protrusions are slidably engaged in the engaging sleeve, the metal pushing rod is formed with a screwing portion corresponding to the screws of the insulative annular body for screwing to each other.

9. The swiveling light pen with a silicone grip as in claim 1, wherein the gripping portion is assembled with a silicon portion thereon, and a hollow converging portion formed on a front end of the gripping portion, wherein the silicon portion has a concave shape on a periphery thereof, and two convexes are respectively formed at two ends thereof for converging light forward, the converging portion being composed of two sections of contiguous conical light-guiding portions with different respective obloquies.
